(19) United States
(12) Patent Application Publication
(10) Pub. No.: US 2008/0104104 A1
(43) Pub. Date: May 1, 2008

(54) HEALTH INTEGRATION PLATFORM SCHEMA

(75) Inventors: Sean Patrick Nolan, Bellevue, WA (US); Johnson T. Apacible, Mercer Island, WA (US); Jeffrey Dick Jones, Woodinville, WA (US); Vijay Varadan, Bellevue, WA (US); Cezary Marcjan, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/745,898

(22) Filed: May 8, 2007

Related U.S. Application Data
(60) Provisional application No. 60/863,897, filed on Nov. 1, 2006.

(51) Int. Cl. G06F 17/30

(52) U.S. Cl. 707/102; 707/E17.127

(57) ABSTRACT

A schema for storing health related data within a health integration network is provided to facilitate housing the data in a common and easy transformable and accessible manner. Utilizing this schema, disparate otherwise proprietary applications can store data formatted according to their own schema within the health integration network providing common accessibility to other applications. The other applications can request the commonly stored data from the health integration network to facilitate data transmission between the disparate applications.

### CROSS-REFERENCE TO RELATED APPLICATION(S)

This application claims the benefit of U.S. Provisional Patent Application Ser. No. 60/863,897 filed on Nov. 1, 2006, entitled “INTERACTIVE AND INTUITIVE HEALTH AND FITNESS TRACKING,” the entirety of which is incorporated herein by reference.

### BACKGROUND

The evolution of computers and networking technologies from high-cost, low performance data processing systems to low cost, high-performance communication, problem solving, and entertainment systems has provided a cost-effective and time saving means to lessen the burden of performing every day tasks such as correspondence, bill paying, shopping, budgeting information and gathering, etc. For example, a computing system interfaced to the Internet, by way of wire or wireless technology, can provide a user with a channel for nearly instantaneous access to a wealth of information from a repository of web sites and servers located around the world. Such a system, as well, allows a user to not only gather information, but also to provide information to disparate sources. As such, online data storing and management has become increasingly popular.

For example, collaborative social networking websites have exploded world-wide. These sites allow users to create remotely stored profiles including personal data such as age, gender, schools attended, graduating class, places of employment, etc. The sites subsequently allow other users to search the foregoing criteria in an attempt to locate other users—be it to find a companion with similar interests or locate a long lost friend from high school. As another more practical example, banking websites offer users the ability to remotely store information concerning bills to be paid. By utilizing this feature, users can automatically schedule bill payments to be made from their bank account which will be automatically debited when the payment is scheduled. This allows simultaneous electronic management of account balancing and bill paying such to save the user from manually entering checks into the register of their checkbook.

Another area of great interest in this country and the entire world is personal health and fitness. Many vastly differing concerns can be discussed in this area, such as setting and obtaining personal fitness goals and the vastly disparate topic of the inefficiencies existing in our health system. For example, today an individual wishing to receive pharmaceutical treatment for illness must first see their primary care physician. Before seeing the physician, the patient will, many times, be required to show their health insurance coverage card. During the visit, the physician will typically write a prescription for the patient. The patient, then, takes the prescription to the pharmacy for fulfillment at which time they may need to furnish their health insurance coverage card again. The pharmacy fills the prescription, notifies insurance, deducts any coverage amount and transfers the prescription to the patient upon payment of the balance. These manual steps are time-consuming, annoying, inefficient, and prone to errors.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

A schema to facilitate storing data within a health integration network is provided wherein disparate applications can request storage of data according to the schema to allow subsequent applications/users to access the data. In this regard, the subsequent application/user needs little knowledge of the application requesting storage of the data as the data is stored according to the common schema. Moreover, the schema can provide for storage of information about the data (metadata, for example) such as information regarding the layout of the data. For example, the data can be stored in an extensible markup language (XML) format, and thus the metadata can contain an XML schema definition (XSD) representation of the stored data.

The main container for data stored in the health integration network can be a health and/or fitness record; these records can comprise a plurality data items referred to hereinafter as “things.” The things can be, for example, data relating to health such as blood pressure readings, insurance information, prescriptions, family history, personal medical history, diagnoses, allergies, X-rays, blood tests, etc. Additionally, the data can be fitness related, such as exercise routines, exercise goals, diets, virtual expeditions based on exercise routines, competitions, and the like, for example. The schema facilitates storing the data in a common format for subsequent retrieval, modification, and other access. Applications can request storage of this data, for example, where the data was acquired by the application through manual input and/or automatic reading and the like. For example, a blood pressure monitor can take a reading from a user and automatically request storage of the reading. In this case, a schema component can take the reading data and conform it to a schema accepted by the health integration network. Subsequent applications/users (including the blood pressure monitor) can request retrieval and perhaps modification of this data. It is to be appreciated that the things are not required to relate to any specific users and can be universal to the system.

In addition to the foregoing types, the data stored in the health integration network according to the schema described herein, can also be data about users in the system, groups of users, applications accessing the system, data about records (which can comprise multiple subrecords or “things”), the subrecords or “things” themselves, policies, queries, record audit information, vocabularies (including code systems, for example), authorization/authentication information for a portion or the entirety of items in the schema, and the like. It is to be appreciated that the subject matter described is not so limited to these types of information.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of an exemplary system that facilitates utilizing a schema component to schematize data.

FIG. 2 illustrates a block diagram of an exemplary system that facilitates utilizing a schema component to schematize data in accordance with a health integration network.

FIG. 3 illustrates a block diagram of an exemplary schema component that can receive, schematize, and store data within a health integration network.

FIG. 4 illustrates a block diagram of an exemplary system that facilitates storing personal health information by utilizing a schema component.

FIG. 5 illustrates an exemplary schema in accordance with a health integration network.

FIG. 6 illustrates an exemplary schema in accordance with a health integration network.

FIG. 7 illustrates an exemplary schema in accordance with a health integration network.

FIG. 8 illustrates an exemplary schema in accordance with a health integration network.

FIG. 9 illustrates an exemplary schema in accordance with a health integration network.

FIG. 10 illustrates an exemplary schema in accordance with a health integration network.

FIG. 11 illustrates an exemplary schema in accordance with a health integration network.

FIG. 12 illustrates an exemplary flow chart for schematizing and storing received data.

FIG. 13 is a schematic block diagram illustrating a suitable operating environment.

FIG. 14 is a schematic block diagram of a sample-computing environment.

### DETAILED DESCRIPTION

A data schema is provided to facilitate managing data within a health integration network. The schema can further define data from a plurality of sources and relating to a plurality of users in a common format to facilitate seamless access to the data from a variety of applications. By providing this functionality, applications submitting data for storage within the health integration network need not be concerned with how the data is to be stored, and applications accessing data from the health integration network can use a common interface that knows how to utilize the schema to retrieve, modify, or otherwise access requested information. In this way, the schema allows the health integration network to be centrally stored and accessed by a number of different users, devices, applications, and the like. The data schema provides for storage of individual records related to health (including storage of actual data values, data types for the values, and the like), directory information (such as user accounts and management, application/device registration, record location, authorization rules, and the like), and translation information, such as available codes and descriptions that applications can take advantage of to provide ease of use for one party and intuitive analysis for another (for example, using a health diagnosis code so a doctor can just store the code and a user application can access information in accordance with the schema to translate the code to verbiage). Storage of individual records is extremely flexible; the individual records can be data stored according to extensible markup language (XML) where the XML is stored as a value in the data store. Additionally, individual records can be related to other data, such as binary data (images/x-rays and the like); however, the information is stored with the record such that the data is interrelated allowing another application (or API and the like) to provide seamless access to both types of data though they are stored in different logical and/or remote locations.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

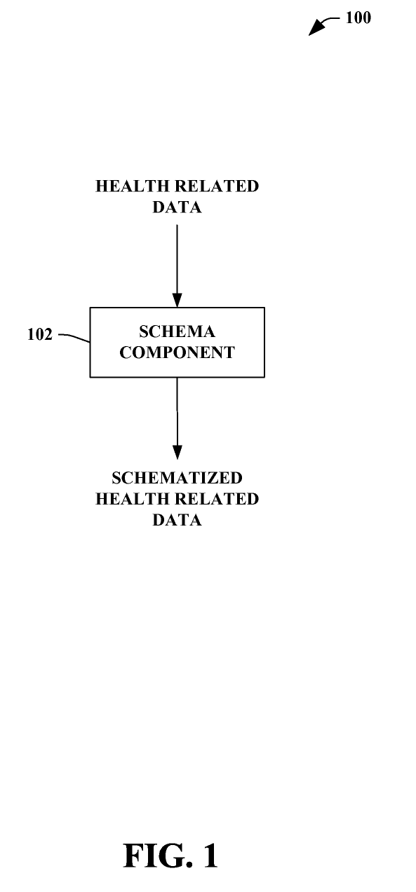

Now turning to the figures, FIG. 1 illustrates a system 100 that facilitates ensuring data conforms to a schema. A schema component 102 is provided to receive data, such as health related data. The schema component 102 can verify that the data conforms to a specified data schema. The schema component 102 can also take disparately formatted data and reformat the data to conform with the specified schema. Once the schema component 102 verifies that the data is conformant with a desired schema, the schematized version of the data can be output and stored in a data storage component, for example, or otherwise used in accordance with the subject matter described herein.

The schematized health related data shown can be related to many aspects of the health integration network. For example, the data can be a record corresponding to health related data such as a medical diagnosis; the data can come from many sources including an application used at a doctor's office or perhaps some sort of automated diagnosis device such as a home pregnancy test. The schema component 102 can take data from these different types of sources and conform it to a single schema that is operable in a centralized health integration network. Following storage of the data, many devices can access the recorded information, subject to authorization rules. The data can also be related to a new application desiring to register with the health integration network. For instance, the data can include information regarding the name of the application, devices able to access the application, authorization rules for data of the applications, different data types defined and useable by the application; this information can be stored according the schema described herein. Using the schema ensures a common storage of data which provides seamless accessibility of the data for subsequent users and applications. The data can also be other data related to a user, specifically concerning account information, such as user name, password, and the like. Information such as insurance info, medical history, allergies, etc. are defined as the individual health records described supra. This data can be forced into a schema, by the schema component 102 for simple subsequent access.

By ensuring the data conforms to the schema, subsequent applications can add value to the data since they know how it is stored (or have access to such information via various components such as an application program interface (API)). For example, applications can request, store, and otherwise access the health related data. A home pregnancy test, for example, can submit a positive pregnancy result to the health integration network; subsequently, an application running at a doctor's office can pick up this data, or can be informed by way of an event or alarm, and prompt a receptionist or doctor using the application to schedule an appointment with the user. In addition, the appointment can be automatically downloaded by a general scheduling software application running on the user's computer and the user can confirm, deny, or reschedule the appointment. This interaction can go on and on, taking on various different forms and permutations. It is to be appreciated that the subject matter described herein is not so limited to the foregoing example; rather this is merely one example of the limitless possibilities rendered possible by the described matter.

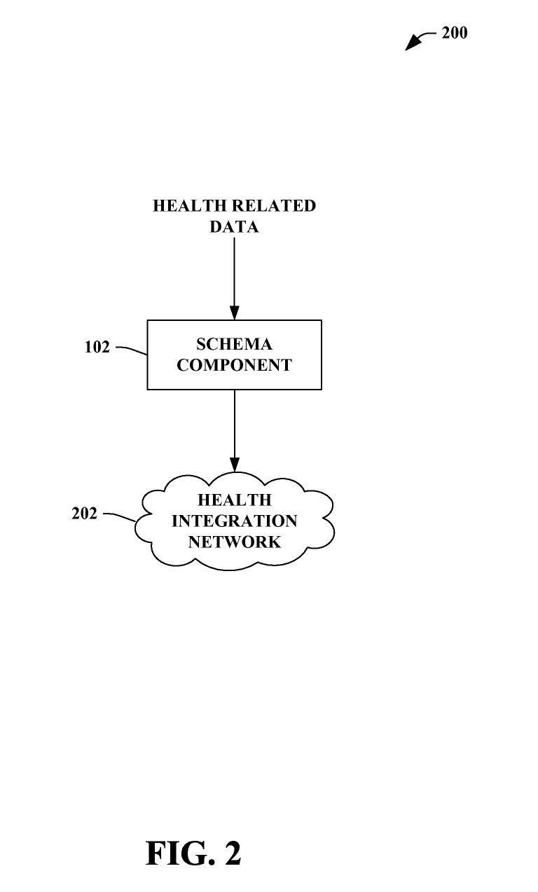

FIG. 2 illustrates a system 200 that facilitates ensuring health related data conforms to a schema upon being stored. A schema component 102 is provided that receives health related data to be stored in a health integration network 202. The schema component 102 ensures data conforms to a specified schema, whether by confirmation or forcing the data to fit within the schema, upon pushing the data into the health integration network 202. The health integration network 202 can comprise one or a plurality of data stores having different logical schemas for the data. It is to be appreciated that the data stores can be relational and/or hierarchically designed, as well as any other design, such as flat file, etc. The schemas can be interrelated such that data entries from one schema can correspond to another schema. For example, one schema can be for housing information regarding health records for a given user. The schema can force an entry for a user ID which can be used in a subsequent data store to locate additional information regarding the user to which the record relates. The schema component 102 ensures the incoming health related data conforms to the appropriate schema(s).

As one example, the schema component 102 can receive data regarding registration of an application for use by general home users. The data can comprise information regarding application name and some defined data types, for example, blood pressures, diet plans, fitness plans, and the like. The schema component 102 can apply a schema to this data to make it conformant to store in the health integration network. Once stored, the application can retrieve and store the desired information according to the data it provided to the health integration network. For example, a user may have a blood pressure monitor that can communicate with the health integration network. The user's blood pressure can be taken by the monitor, which is a registered application, and the monitor can request storage of the data. The schema component 102 forms the data to a format acceptable by the health integration network or utilizes the data stores within the health integration network to properly store the data. Subsequently, the user's home application can query the health integration network for the stored blood pressure reading. Likewise, different brands of blood pressure monitors can be used to take and record blood pressure—or the blood pressure can even be entered manually at a doctor's office (for example and through a registered application)—and the health integration network stores the data commonly so subsequent applications can utilize the data regardless of the source.

The data can originate from a variety of sources including, but not limited to, any medical device such as those having outputs (e.g. blood pressure monitor, weight scale, blood/sugar level monitor, IV, pacemaker, stethoscope, x-ray, etc.), personal fitness tracking devices (combination heart rate monitor watches, pedometers, bicycle equipment (such as speedometers, altimeters, odometers, etc.), stop watches, and the like), and other applications including user interfaces for personal use and medical use. Also, the data can be any data such devices and applications can possibly output including, but not limited to, blood pressure readings, blood/sugar levels, heart rate, body temperature, cholesterol level, images, bicycle/walking speed and distance, fitness routine specifics, diet routine specifics, virtual fitness tracking information, and the like. The data and devices producing the data are virtually limitless.

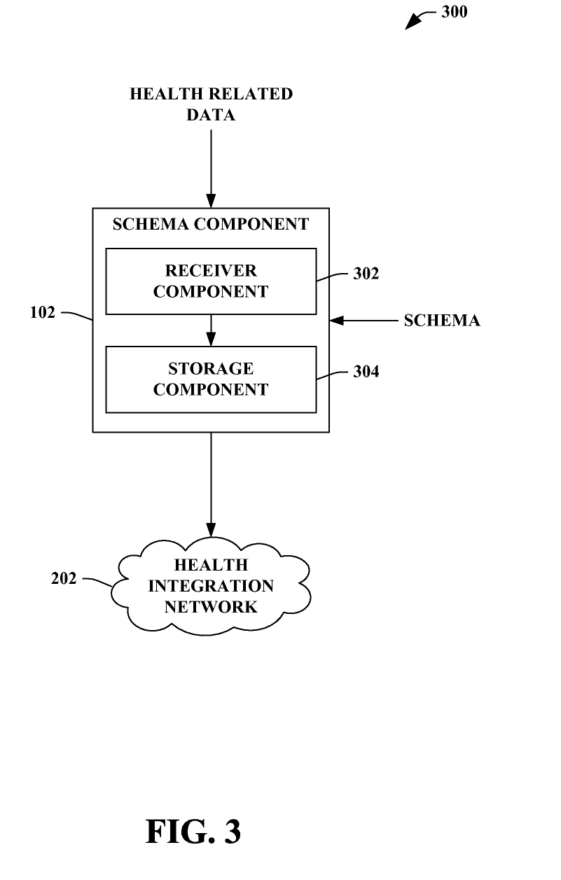

Referring to FIG. 3, an example system 300 that facilitates applying a schema to received data and storing the data is shown. A schema component 102 is provided comprising a receiver component 302 and a storage component 304. The receiver component 302 receives health related data, which can be provided in many different formats or structures. The storage component 304 receives the data after a schema is forced over the data and stores the data in the health integration network 202 according to the schema. The schema can be independently stored and applied by the schema component 102. Additionally, the schema can be a set of rules utilized by the schema component 102 to make data compliant with storage in the health integration network 202.

The receiver component 302 can receive health data related to many aspects of personal health and fitness. For example, the data can be an individual health record or reading, data for an application registered with the health integration network 202, security data regarding certain records or portions of the health integration network 202, data types utilized by the health integration network 202 or different applications, rules on translating data (by way of transformation, applying a style, applying a schema, and the like), etc. The receiver component 302 and/or the storage component can apply the schema rules to the health related data. Alternatively, another component can apply the schema rules. It is to be appreciated that this process, as well as receiving and storing the data, is not limited to being performed by or within the schema component. Additionally, the schema component 102 is not limited to operating outside of the health integration network 202; rather it can also be integrated within the health integration network 202.

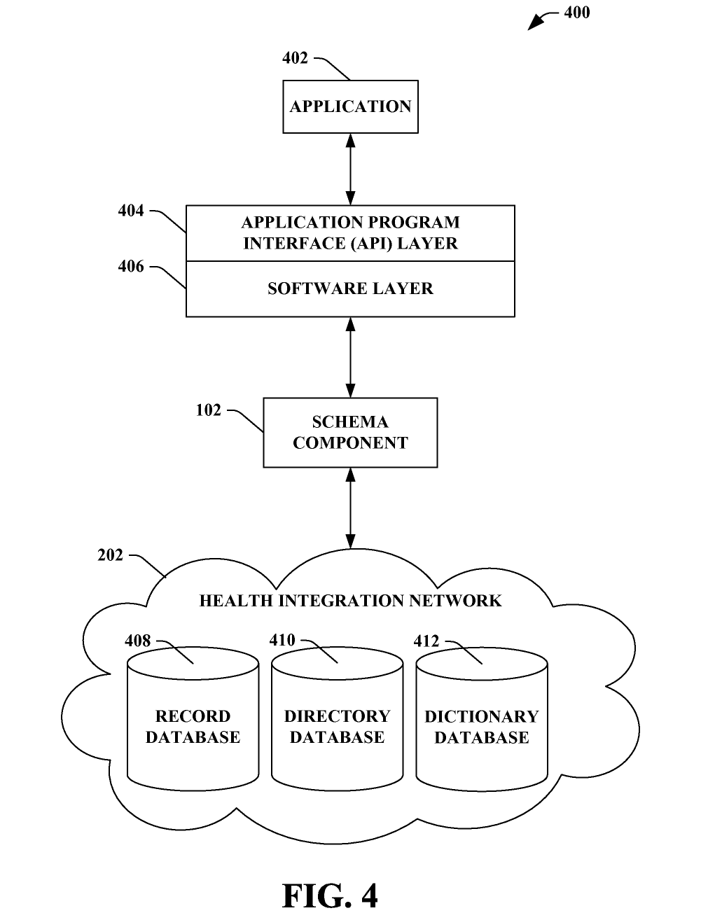

Referring to FIG. 4, an example system 400 that facilitates accessing information within a health integration network according to a schema is shown. An application 402 can at least one of display or specify health related data. It is to be appreciated that the application 402 can be many different types of applications, as mentioned above, including software applications, electronic devices executing a software application, electronic devices alone, legacy devices interfaceable with a device executing a software application, and the like. The application can utilize the API 404 to request and store data within a health integration network 202. It is to be appreciated that the API 404 can synchronously or asynchronously communicate with a plurality of applications 402 of similar or different types. The API 404 can also have a software layer 406 to leverage in interpreting and processing the request. The software layer 406 can be separated out as shown, or it can be integrated within the API 404, the health integration network 202, or both. A schema component 102 is additionally provided to ensure data to be stored in the health integration network 202 complies with a data storage schema. It is to be appreciated that the schema component 102 can be a separate component, but also can be integrated within the API 404, software layer 406, and/or the health integration network 202 as well.

Upon interpreting and processing a request from the application 402 to store data, the API 404 can process the storage request, and/or can leverage the software layer 406 for processing. The schema component 102 can be utilized to ensure the data to be stored is stored properly within a schema employed by the health integration network 202. It is to be appreciated that there can be a plurality of APIs 404, software layers 406, and schema components 102 connecting to a centralized health integration network 202, and the centralized health integration network 202 may be a single system or distributed across multiple systems, platforms, and the like.

The health integration network 202 can comprise a plurality of data stores including a record database 408, a directory database 410, and a dictionary database 412. In addition, the health integration network 202 can comprise many other systems and/or layers to facilitate data management and transfer. Furthermore, the databases can be redundant such that multiple versions of respective databases are available for other APIs and applications and/or a back-up source for other versions of the databases. Additionally, the databases can be logically partitioned among various physical data stores to allow efficient storage and retrieval for highly accessed systems. Providing separate partitions and/or databases can allow varying levels of security across the disparate partitions/databases. This can be advantageous to provide compliance with regulations, for example, such as Health Insurance Portability and Accountability Act (HIPAA) where perhaps the health records need tight security to be in compliance with HIPAA requirements, but data types and vocabulary lookups can require little or no security. Moreover, the databases can be hierarchically based, such as XML and/or relationally based. The record database 408 can be highly distributed and comprise personal health related data records for a plurality of users. Thus, it can be beneficial for the record database to be distributed to many different types of databases even—relational and hierarchical (XML) alike. In this regard, the health integration network can support a plurality of different architectures and structures. The records can be of different formats and can comprise any kind of data (single instance, structured or unstructured), such as plain data, data and associated type information, self-describing data (by way of associated schemas, such as XSL schemas for example), data with associated templates (by way of stylesheets for example), data with units (such as data with conversion instructions), binary data (such as pictures, x-rays, etc.), and the like. Moreover, the record database 408 can keep an audit trail of changes made to the records for tracking and restoration purposes; the schema component 102 can automatically enter records into the audit trail portion of the record database 408 upon modification of the records, authorization rules related to the records and the like. Additionally, any data type or related instances of the foregoing information can be stored in a disparate database such as the dictionary database 412 described infra. The record database 408 can be partitioned, distributed, and/or segmented based on a number of factors including performance, logical grouping of users (e.g. users of the same company, family, and the like).

The directory database 410 can store information such as user account data, which can include user name, authentication credentials, the existence of records for the user, etc. The directory database 410 can also house information about records themselves including the user to whom they belong, where the record is held (in a distributed record database 408 configuration) authorization rules for the records, etc. For example, a user can specify that a spouse have access to his/her fitness related data, but not medical health related data. In this way, a user can protect his/her data while allowing appropriate parties (such as spouse, doctor, insurance company, personal trainer, etc.) or applications/devices (blood pressure machine, pacemaker, fitness watch, etc.) to have access to relevant data. In addition, the directory database 410 can comprise data regarding configuring applications 402 to interact with the health integration network 202; applications 402 can be required to register with the health integration network 202, and thus, the application data in the directory database 410 includes the registration information.

The dictionary database 412 can hold information relating to vocabulary definitions used by the health integration network 202 and requesting entities such as the API 404 and software layer 406. Such definitions can include data type definitions and information on how to display the different data types or transform them. Additionally, the dictionary database 412 can hold information for display layouts and templates, etc. Furthermore, the dictionary database 412 can hold different look-up tables that define codes through the use of standards and the like. For example, the dictionary database 412 can support International Classification of Diseases, ninth revision (ICD-9) released by the National Center for Health Statistics. These codes identify different diseases and diagnoses; thus a doctor can put one of these codes on a user's chart in the health integration network 202, and the dictionary database 412 can allow the software layer 406 (or API 404) to translate this code into something that makes more sense to the user, such as medical name and/or different, other, or additional information concerning the diagnosis. Separating the databases out and providing authentication/authorization information to be stored, for example, in the directory database allows application developers to utilize the health integration network without having to implement authentication/authorization procedures for use with their applications. Moreover, the databases can provide record level authorizations as an additional layer of security. The dictionary database 412 can also be used to retrieve other metadata such as plural and abbreviated forms of the codes. It can also hold information that allows conversion between different measurement units, such as between feet to meters, Fahrenheit to Celsius, etc.

In one embodiment, the application 402, which can be more than one application, can make a call to the API 404 to store data, for example. The API 404 can leverage the software layer 406 to process the call made by the application 402. The software layer 406 can then utilize the schema component 102 to ensure the data is stored properly within the database or databases 408, 410, and 412 according to the appropriate schema. After storage, the software layer 406 can then return status to the API 404 and back to the application 402. It is to be appreciated that the schema component can reside as a separate component as shown, or within the API 404, software layer 406, and/or health integration network 202. Additionally the functionality can reside alone or together in these components. As an example, an application 202 can request storage of a user's blood pressure reading by calling the API 404, with an XML formatted request for example, which in turn can communicate with the software layer 406 to facilitate storage. The software layer 406 can utilize the schema component 102 to store data about the reading in the record database 408; such data can include one or more entries such as the reading itself, the device used, time of day, etc. The data can be an XML representation of the reading and such. Additionally, the software layer 406 can store information regarding the existence and location of the record in the directory database 410. This way when a request comes in for the data, the software layer 406 can query the directory database 410 to see if the record exists and where to find it, then query the record database 408 to obtain the desired data. It is to be appreciated that the subject matter described is not so limited to the foregoing example/embodiment, but rather this is one of many possible embodiments of utilizing the schema component 102 to ensure proper storage of data.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent, for instance by inferring actions based on contextual information. By way of example and not limitation, such mechanism can be employed with respect to generation of materialized views and the like.

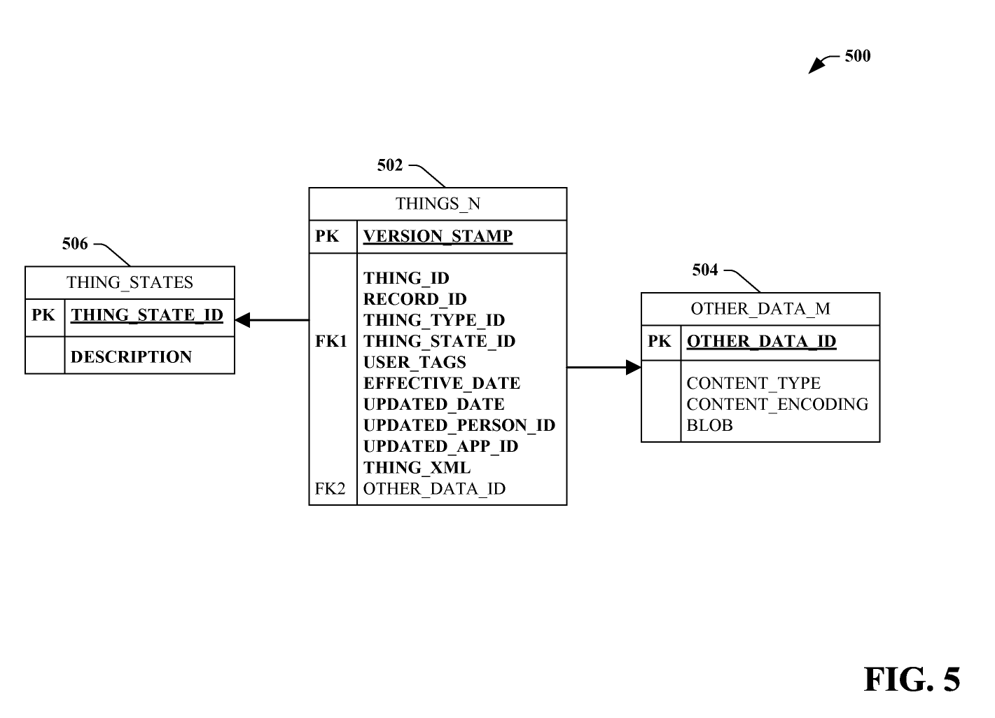

FIGS. 5-11 present example schemas in accordance with storing data related to the subject matter described herein. Respective items identified by reference numerals can be any type of accessible data structure, hierarchical element, relational database table, and the like. For example, the item can represent a portion of an XML file, a database entity (such as a database, table, field, etc.), and the like. It is to be appreciated that the subject matter is not so limited to the following embodiments; rather these embodiments are used to facilitate further discussion of the subject matter.

Referring to FIG. 5, an example schema 500 is shown in accordance with an embodiment of the disclosed subject matter. Data associated with a record and defined by a type will be referred to herein, in examples and figures, as a “thing.” The schema 500 can be used to store things within a health integration network as described above. There can be more than one thing defined for a given record and the schema 500 can be used in storing things within a record database as described in previous figures. The schema 500 can define a THINGS_N 502 item for storing data associated with a thing. The N in the THINGS_N 502 name can represent a physical subpartition of the things data within a data store of a corresponding record. It is to be appreciated that a THINGS_N 502 item can belong or relate to multiple records. The THINGS_N 502 item itself can have a number of associated values such as a thing_id (which can be a unique identifier labeling the thing), a record_id that identifies the record to which the thing relates, and a thing_type_id that holds a value for the data type of the thing. The thing_type_id and record_id, for example, can be cross-referenced with another item that holds additional information regarding the type and record common to all things that relate to them. The THINGS_N 502 item can also comprise a value for XML code that can represent actual value(s) of the thing. The XML can additionally have information regarding transformation, translation, style, and/or schema information for the data. This XML can be the main portion of the THINGS_N 502 item in that it can define the actual substantive data. The thing_type_id can identify the data type for the XML representation of values, and this type can be defined in a disparate schema item such as THING_TYPES described infra. This disparate schema item can hold values common to the types such as a schema representation of the layout of the XML, such as an XML schema definition (XSD) file or representation for example.

The THINGS_N 502 item can also have version_stamp to identify different versions of the things, for example if the data changes. This is helpful in retrieving information during record audits and tracking changes to the associated thing. In addition, the THINGS_N 502 item can have an identifier for other information such as binary information (image/x-ray or the like). The information can also conform to a schema such as the OTHER_DATA_M 504 item. M can also represent a physical subpartition of the things data within a data store of a corresponding record. Moreover, the OTHER_DATA_M 504 item can have values representing the content type of the data, encoding type and rules, as well as the data itself (called binary data or binary large object—BLOB). The THINGS_N 502 can also have a representative state corresponding to a THING_STATES 506 item. This schema provides for a thing_state_id representing a possible state and a description to which the id relates. In addition, the THINGS_N 502 item can store a code and the THINGS_STATES 506 items can be queried to obtain the description for the code. A thing state could be, for example, active, deleted, and the like, which can be useful in record auditing. The THINGS_N 502 item can have values for user tags, which represent data that can be related to user-defined categories and/or common to things in the health integration network. For example, the user can specify many groupings of data to comprise a logical set such as data based on a date or range of dates, types of things, things and/or records having certain values (such as provider id), and many other conceivable combinations. It is to be appreciated that the user tags are not so limited, rather these are examples of many possible user tag sets. The THINGS_N 502 item can also have values for thing maintenance such as person_id and application_id of who updated the thing, effective date, updated date, etc.

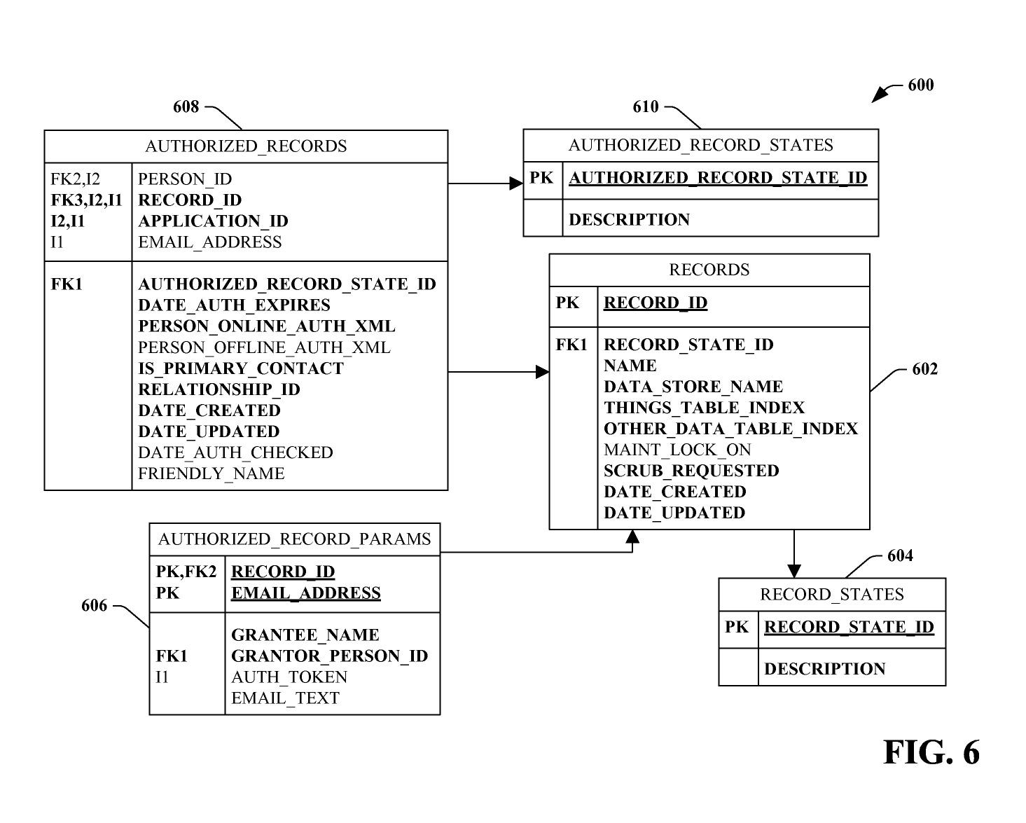

FIG. 6 illustrates an example schema 600 for records in accordance with the subject matter described. The schema 600 can include a RECORDS 602 item that each record can conform to in a health integration network. The RECORDS 602 item can have values representing a record_id that uniquely identifies the record as well as a name. In addition, data_store_name can be provided to identify where things related to the record reside. Using the record_id, the things that can comply to the thing schema above can be queried by record_id. The RECORDS 602 item can also have one or more indices, such as a THINGS_TABLE_INDEX and/or OTHER_DATA_TABLE_INDEX to represent physical subpartitions of things and/or other data related to the things and/or records. The indices can relate to the N and M suffixes described above for the THINGS_N 502 item and the OTHER_DATA_M 504 item. The RECORDS 602 item can have additional information for maintenance and housekeeping such as creation dates and scrub requests. The RECORDS 602 item can also include a state which can conform to the RECORD_STATES 604 item. The RECORD_STATES 604 item can have a state_id to identify the possible states and respective states have a description to aid in determining what a state_id indicates. Possible states include active (indicating the record is in fact active), active read only (indicating the record can not be written with additional data or modified), suspended (indicating that the record is not active at the present time), and deleted (indicating that a delete was requested on the record). By keeping deleted records in the store and marking them deleted (instead of removing them), auditing can be performed to roll back mistakes, etc.

The schema 600 can also provide an AUTHORIZED_RECORD_PARAMS 606 item for use with the RECORDS 602 item. The AUTHORIZED_RECORD_PARAMS 606 item allows authorization grant information to be associated with certain records. For example, a user can compete in a fitness competition and grant access for other competitors to view the competition records related to a user. Thus, the AUTHORIZED_RECORD_PARAMS 606 item can provide values for the record_id to which it applies as well as an associated email address for contact, name of the grantee (the party who is to be authorized to view the record), and the name of the grantor. Also, an associated authorization token can be provided for the record for the grantee to specify when accessing the record. Additionally, the schema 600 can provide an AUTHORIZED_RECORDS 608 item to store information regarding active authorization management of associated records. Thus, the AUTHORIZED_RECORDS 608 item at least has an entry for record_id to identify the record to which it relates. Additionally, a person and application_id are provided as authorization can be at the person and/or application level. Moreover, a record state can be provided with an item, AUTHORIZED_RECORD_STATES 610, that can allow the record states to be associated with a description. Examples of the states include active, activation pending, activation rejected, and the like. Thus, items conforming to the AUTHORIZED_RECORDS 608 item may require a user granted authorization to activate the authorization as a level of security. The AUTHORIZED_RECORDS 608 item can also have values for XML representing authorization information, dates of creation and updating, as well as a relationship id identifying how the authorized user relates to the user to whom the record relates (e.g. doctor, spouse, mother, etc.).

Having separate records and things within those records provides for a mechanism to logically relate portions of data to each other and provide for the portions to be disparately stored according to format and/or architecture. For example, a record can be created relating to a doctor's office visit and things can be provided for weight, blood pressure reading, symptoms, medications, diagnosis (which can relate to a classification system such as ICD-9), follow-up appointment information, insurance information, copay, etc. These values can be input by disparate devices into the same system or network by utilizing the aforementioned schemas. The schema can be applied by a software layer, API, health integration network, or the like as discussed supra. Additionally, the values input can conform to their own schemas and provide their own transformation information. For example, the blood pressure reading can be stored by XML representing two integers and stored with a transformation to allow stylizing of the integers into a string representing systolic/diastolic pressure format. Additionally, the weight can be separately stored, for example, in XML comprising the information as well as data to indicate unit of pounds and/or information on how to translate the data to kilograms, etc.

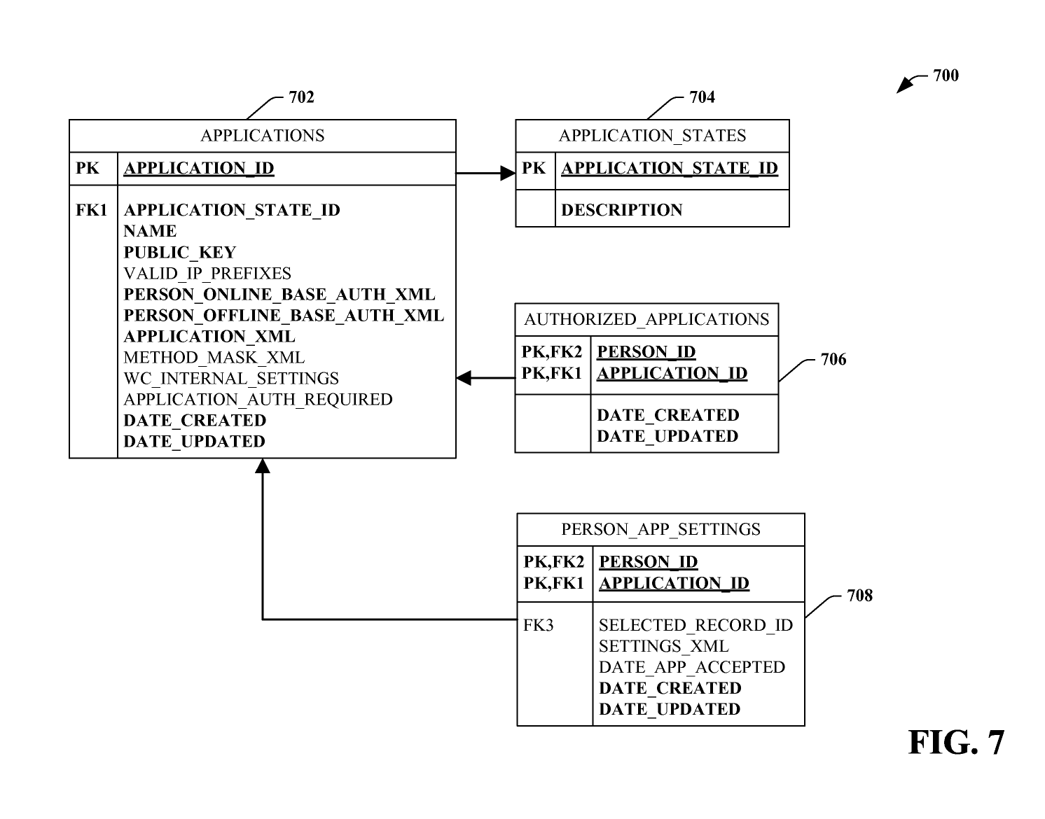

Referring now to FIG. 7, a schema 700 is displayed that can be used in conjunction with storing information about applications registered to utilize a health integration network. An APPLICATIONS 702 item can be provided to define how general information regarding the applications is to be stored. For example, APPLICATIONS 702 item can have an application_id to identify the specific application to which it relates. A name can be provided to identify the application as well; also, a public key value is provided for encrypting data corresponding to the application (the application holds the private encryption key to decrypt relevant data). Moreover, XML can be provided corresponding to additional information related to the application such as default settings and the like. General information such as record creation and update dates can also be provided, as well as a state that relates to an item conforming to an APPLICATION_STATES 704 item. This item can have available application state codes as well as descriptions for identifying the state. Possible states can include active, needs verification (application can be required to verify itself after registering, adding another layer of security), suspended, deleted, and the like.

Additionally, an AUTHORIZED_APPLICATIONS 706 item can be provided to establish information regarding applications a person is authorized to use. Thus, the item can have properties relating to a person_id and associated application_id as well as date record information. A PERSON_APP_SETTINGS 708 item can be provided as well to facilitate storing information about personal application settings. These settings can be in XML format, thus an entry can be provided for such settings in XML format along with a person_id and application_id identifying the person and application to which the settings relate. Having such an item in schema 700 to identify information about applications allows applications to access information about relationships with people and records in a common format.

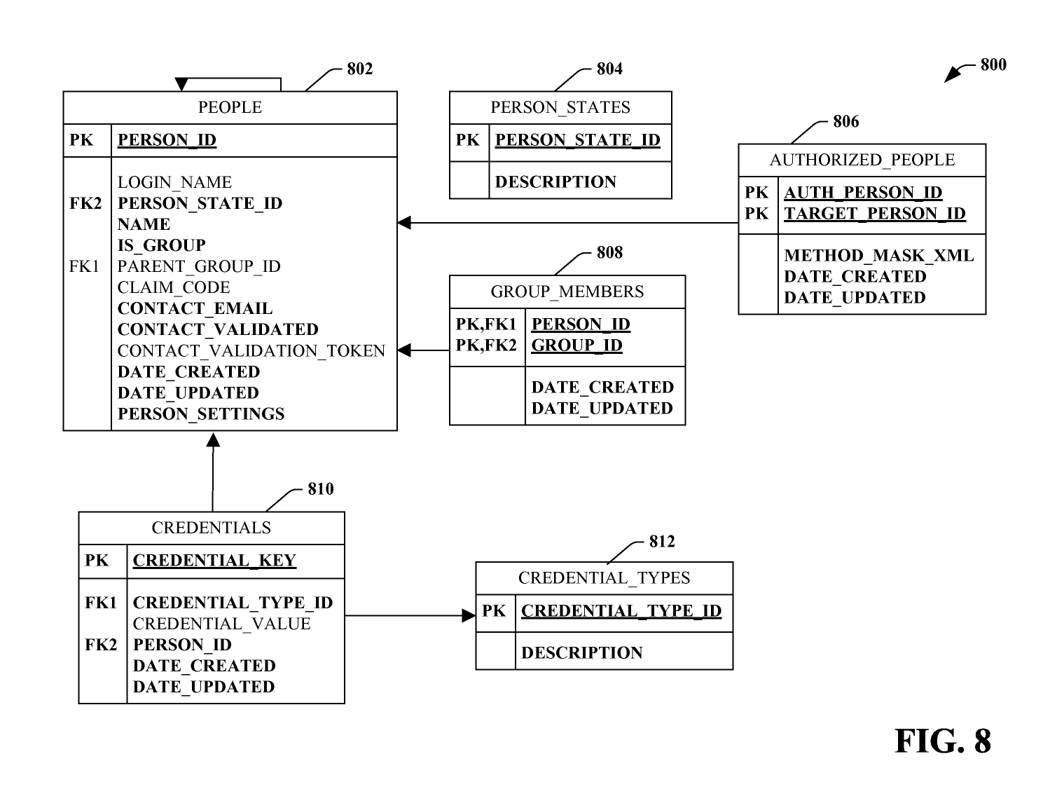

FIG. 8 illustrates a schema 800 for organizing and storing information about users in a health integration network. To this end, a PEOPLE 802 item can be provided to store information regarding the individual users. For example, the PEOPLE 802 item can require a person_id that uniquely identifies respective users in the network. This can be the same person_id used in the aforementioned (and subsequent) schemas such to relate other values to a user (such as in the application authorization process, etc.). A login_name and real name can also be stored to further identify the user as well as an email address. Authorization tokens for certain data can also be applied to records of the PEOPLE 802 item along with any group information. The schema 800 can provide for groups to more easily apply authorizations and other settings to users if they are in some way related. Group information can also be in accordance with a GROUP_MEMBERS item 808 for example which identifies respective groups (by a unique group_id for example) as well as a list of person ids of people in the group. Also date information regarding the creation and updating of values in the items can be provided. The PEOPLE 802 item can also have a related state for associated values. The state can also comply to a PERSON_STATES 804 item having a state_id related to possible states and a description to identify what the states indicate. Possible states can include active, suspended, deleted, etc., as described above. The schema 800 can also have an associated AUTHORIZED_PEOPLE 806 item for authorizing certain parties to access given routines and/or data within the health integration network. Additionally, the item can specify other entities that the requesting party can impersonate to obtain desired data. An XML schema can be provided in this item representing a mask of methods that the authorized disparate user has authorization to utilize in conjunction with the person to whom the data relates. Additionally or alternatively, the XML can identify methods unavailable to the authorized disparate user.

The schema 800 can also have associated sets of credentials related to the users in the data complying with the PEOPLE 802 item. An item, CREDENTIALS 810, can be provided to facilitate storing this type of information. This item can store a credential key related to the type of credential as well as a type_id to represent the credential type. This type_id can further relate to a CREDENTIAL_TYPES item 812 which can have value representing a credential type and description of the type. Possible types, for example, can be user/password type login, domain type login, web login, HTTPS login, etc. The CREDENTIALS 810 item can also have an associated person_id with which to associate the credential type. Utilizing a schema 800 to allow storage of such credential data can facilitate a single sign-on type service where accessing of different types and architectures can be associated to allow a user to login once to one kind of system and use disparate systems in conjunction with the health integration network without requiring further authentication. Moreover, the disparate applications need not implement authentication/authorization rules at all as the health integration network can provide this functionality.

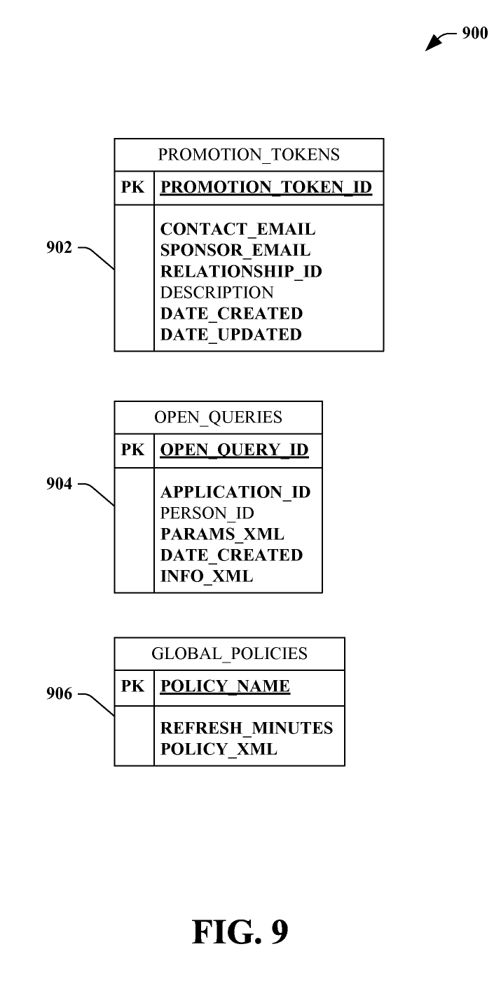

Turning now to FIG. 9, another schema 900 is shown which can relate to data stored within a health integration network. Additional value-add functionalities can be performed from within the health integration network regarding the data. This schema 900 can represent a way to store additional data related to these functionalities. At 902, a PROMOTION_TOKENS item can be provided to represent outstanding promotions tokens offered to users to create an account within the health integration network. Such promotion tokens can be sent to a user of a disparate associated system, for example, to extend the ability of that user to sign up for an account in the health integration network. In this way, membership can be limited providing for regulation of users/accounts as well as an additional layer of security for the system (preventing malicious subscribers, etc.). A value representing the description can also be in the PROMOTION_TOKENS 902 item to identify relevant data regarding the promotion.

Moreover, an OPEN_QUERIES 904 item can be provided to define structure for data relating to a set of queries available from within the health integration network itself, such as queries that do not require the requesting entity to be logged into the health integration network. For example, this item can have values representing a query_id to uniquely identify the query as well as an application_id to identify an application to which the query can relate. It is to be appreciated that this value can relate to application_id in the APPLICATIONS 702 item to correlate data within the health integration network. The OPEN_QUERIES 904 item can also require an XML representation of the query. This could be, for example, the XML an application can use to make a query itself according to an application program interface used to access data the health integration network. The item can also provide the ability to store information relating to parameters used in conjunction with operating the query; these can also be specified in XML, for example. It is to be appreciated, for example, that the health integration network can schedule some or all of the queries stored according to this schema to be automatically run in specified intervals to keep a cache of results mitigating the need to run multiple requests. The schema 900 can additionally provide an item, GLOBAL_POLICIES 906, for storing data related to policies implemented within the system. This item can provide for storage of policy name to identify the policy, a refresh time to specify when to implement the policy, an XML representation of the policy, and the like.

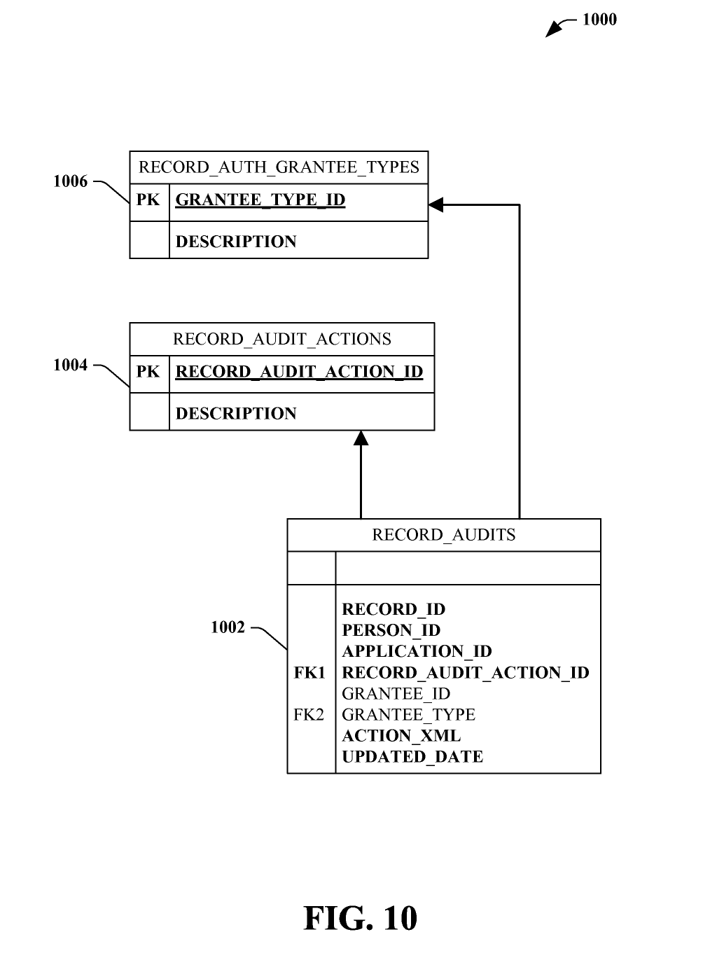

Referring to FIG. 10, a schema 1000 can also be provided to allow storage of data relating to record auditing. The data conforming to this storage schema represents history of some or all records in a health integration network (such as data conforming to the RECORDS 602 item described above). A portion of this schema can be provided to store data regarding actions taken on respective records; this item can be a RECORD_AUDITS 1002 item having a record_id to identify the record to which the auditing information applies. It is to be appreciated that a single record may have any number of associated audit records (from 0 to N, where N is a positive integer). The item can also provide for storage of information regarding the person and application who changed the record (such as person_id and application_id discussed above in relation to other schemas). An XML representation of the action taken against the record can also be stored along with reversal instructions to provide easy rollback of unwanted changes. Additionally, an identifier relating to the action taken can be provided along with another item that identifies the action codes and description of such to provide a user with easy understanding of the action taken. This information can conform to a RECORD_AUDIT_ACTIONS 1004 item, which can have possible values of added, deleted, read, written, and the like. Changes to authorization rules can also be tracked, specifically record level authorization. The RECORDS 1002 item can have values corresponding to a grantee_id and a grantee_type to identify how a level of authorization changed for a given user (grantee). Additionally, a RECORD_AUTH_GRANTEE_TYPES 1106 item can be provided to identify the type of authorization changed and provide a description to what the type indicates.

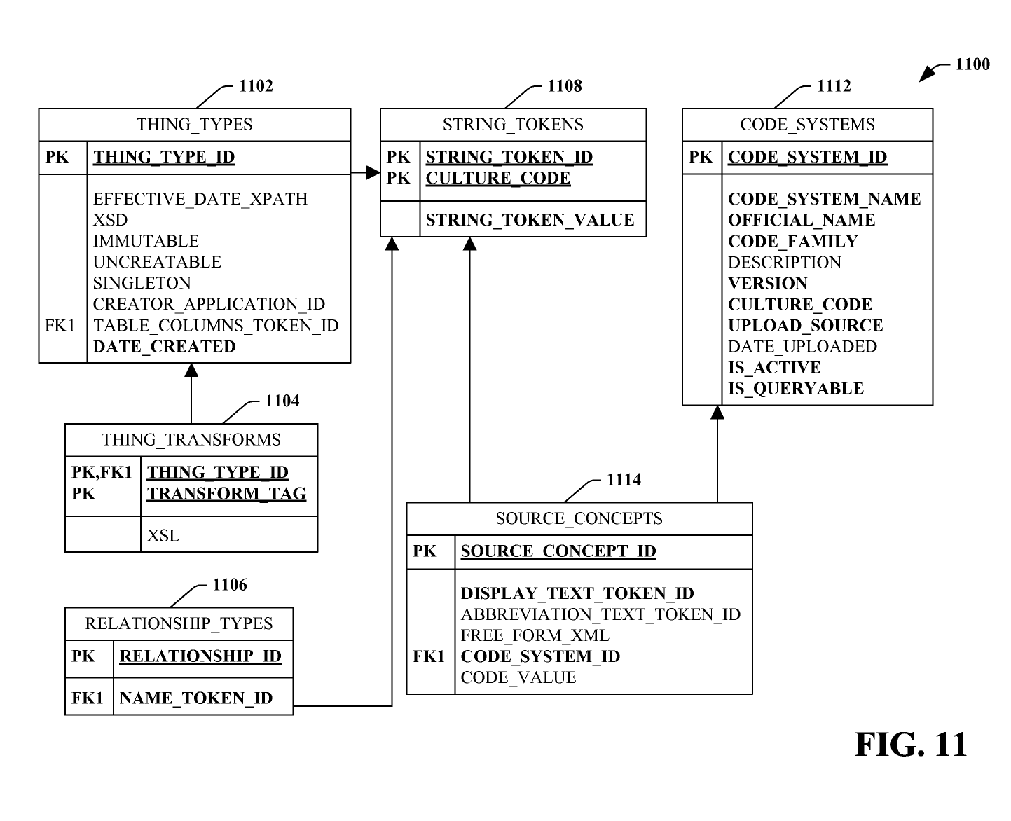

FIG. 11 illustrates a schema 1100 that can be used to define data to be stored in a dictionary database in connection with a health integration network as described above. The schema can support storage of records relating to different types, conversions, transforms, data schemas, and the like within the network. In effect, the dictionary database can provide lookup services for a variety of items to retrieve user-friendly definitions. For example, a THING_TYPES 1102 item can exist in the schema to provide a data specification for items related to available data types for things in the network. The THING_TYPES 1102 item can require a thing_type_id to uniquely identify respective types within the database. The item also provides an XML schema definition (XSD) to identify the layout of the data within the type. This can be used to check conformance of data with a specified type to ensure integrity of the data for example. Other values can be provided to identify aspects of the type such as if the type is to be creatable or not, whether the type is immutable, meaning the item is not modifiable after created, and also whether the type is singleton (meaning only one instance exists), and the like. Things in a record database, such as those conforming to the THINGS 502 item as described above, can utilize this item to store data regarding types relating to those things. The data in the health integration network is further integrated by the schemas in this way. The THING_TYPES 1102 item can additionally specify the application which created the data type. It is to be appreciated that once created, data types can be used by disparate application to both request and store data. Examples of thing types definable under this item 1102 and part of this schema 1100 can be profile (relating the profile of a user), document, fitness_measurement, provider, medication, allergy, lab_result, emergency_contact, data_feed, application specific types (including any types relating to establishments using specific applications such as pharmacy, doctor's office, as well as devices such as those mentioned supra).

A THINGS_TRANSFORM 1104 item can additionally exist in the schema 1100 to define instructions for transforming given types to another type, format, or architecture. For example, a thing_type_id can be provided to identify the thing to which the transformation relates as well as a transform tag that perhaps uniquely identifies the transform. Moreover, an XML stylesheet (XSL) can be stored according to a transform item that can be applied to the data resulting in the appropriate representation of the transformed data. Using this method, many different transform types can be created, including really simple syndication (RSS), any stylized string representations, HTML, and the like. To identify the different types and other items that can be in the dictionary database, as will be further specified below, the schema 1100 can provide a STRING_TOKENS 1108 item. This can provide, for example, data such as a string_token_id to uniquely identify the string tokens in the database that conform to this item specification, as well as the string value. Also, a culture_code can be provided to identify a culture to which the string token can relate; this includes language or dialect and country combinations, for example, such as America/English, UK/English, China/Mandarin, Canada/English, Canada/French, etc. As mentioned, the string can tie back to a thing type to help a user or developer to identify or otherwise display the type.

Additionally, the STRING_TOKENS 1108 item can also define data for a RELATIONSHIP_TYPES 1106 item, and the associated data can apply labels to relationship types important to a health integration network such as the relationship between two people defined in the PEOPLE 802 item (such as father, mother, spouse, sibling, doctor, personal trainer, etc.). The RELATIONSHIP_TYPES 1106 item can have a relationship_id which can be the same as used in previously described schemas, and a name_token_id that can match up with a string_token_id in data defined by the STRING_TOKENS 1108 item.

Another example of data that have a definition in the schema 1100 is that related to code systems (such as ICD-9 mentioned above). For this data, a CODE_SYSTEMS 1112 item can be implemented to conform data related to these systems, providing entries for a code_system_id, for example, to uniquely identify respective code systems available in a health integration network. Additionally, the CODE_SYSTEMS 1112 item can also provide a plurality of names representing common names as well as official names. Moreover, a code family can be provided that represents different groupings of codes, as well as a version of the code, culture code (as mentioned above), upload source, and the like. Also, some status identifiers can be provided such as whether or not the code is queryable and active. These can also be state codes conforming to a state schema as shown supra. Furthermore, a SOURCE_CONCEPTS 1114 item can be provided to define different items related to the CODE_SYSTEMS 1112 item. For example, a display_text_token_id can be provided that can relate to an item conforming to the STRING_TOKENS 1108 item for displaying a user-friendly text string. Additionally an abbreviated version of the string can be provided as well as some free form XML to express the relevant data. Also, the SOURCE_CONCEPTS 1114 item can provide the code_system_id to which it relates.

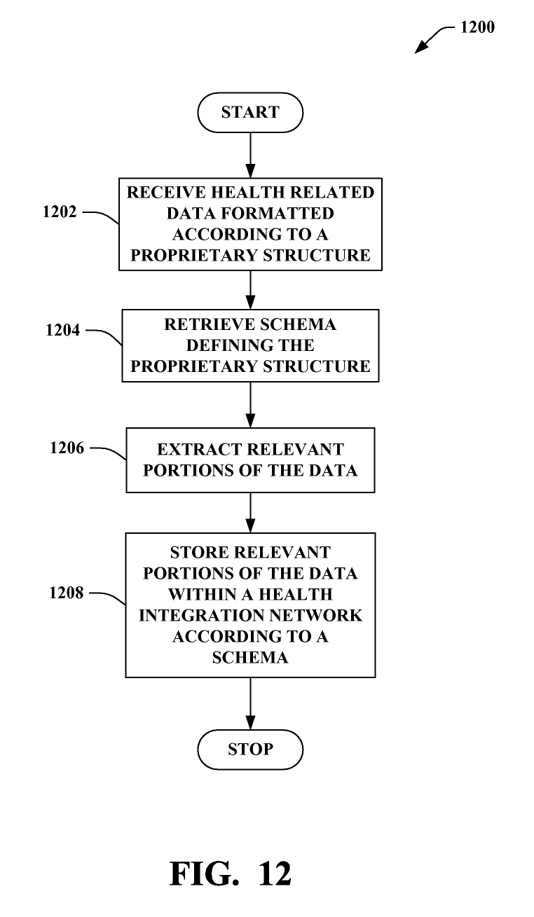

In view of the exemplary systems and schemas described supra, methodologies that may be implemented in accordance with the disclosed subject matter will be better appreciated with reference to the flow chart of FIG. 12. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 12 shows a methodology for storing data within a health integration network. Specifically, the data can be stored according to a disparate storage format and a schema defining the format can be provided. This schema can be used to interpret the data and store it according to the format of the respective database in the health integration network. In particular, at reference numeral 1202, data is received according to a proprietary format. This can include data formatted according to many procedures and sent to the schema component with instructions and/or data (metadata) about how to interpret the data. Additionally, the data can come via function call to the schema component. In this case, the schema component can offer an application program interface (API) and/or a software development kit (SDK) that can be utilized by a plurality of disparate applications, layers, and/or other APIs in the health integration network to store health related data.

At 1204, a schema relating to the layout of the health related data is retrieved; this retrieval can be from a parameter passed in by function call, from a disparate data source, and/or from within the health integration network (e.g. within another database). Utilizing the layout provided in the schema, the health related data can be interpreted and stored according to a schema of the health integration network. However, the totality of the data presented might not be needed in its entirety, and thus at 1206, relevant portions of the data can be extracted. This provides for functionality with a greater number of systems since the storage is not limited to a proprietary format on the health integration network end; rather data can come in from a variety of data sources and be stored in a common format to facilitate data communications between the proprietary applications. Thus, at 1208, this data is stored within the health integration network according to such a schema. The storage schema can be defined by the health integration network itself, and/or another application. Either way, the schema itself can be stored with the data (in a disparate database perhaps) and when data of the type is accessed, the schema can be transmitted along with the data to provide instruction for interpreting the data as stored.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

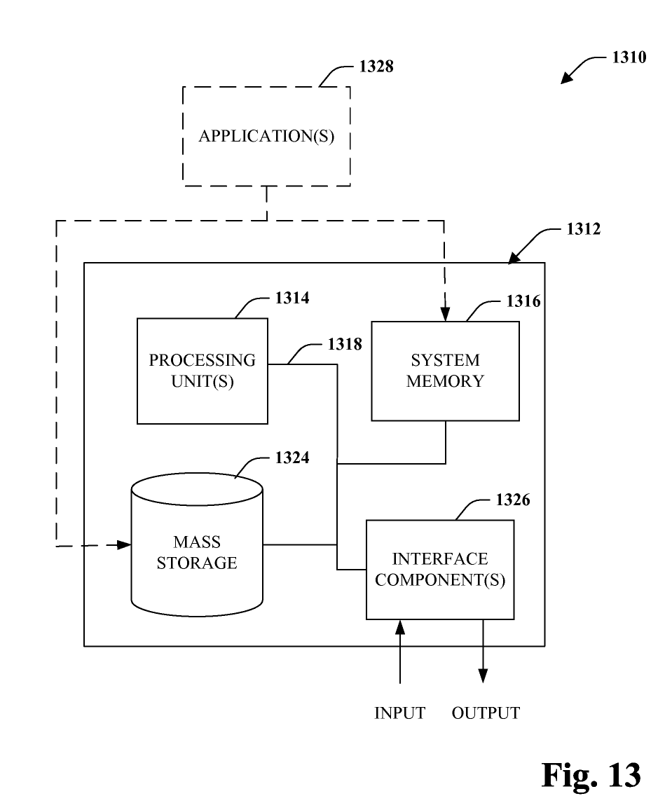

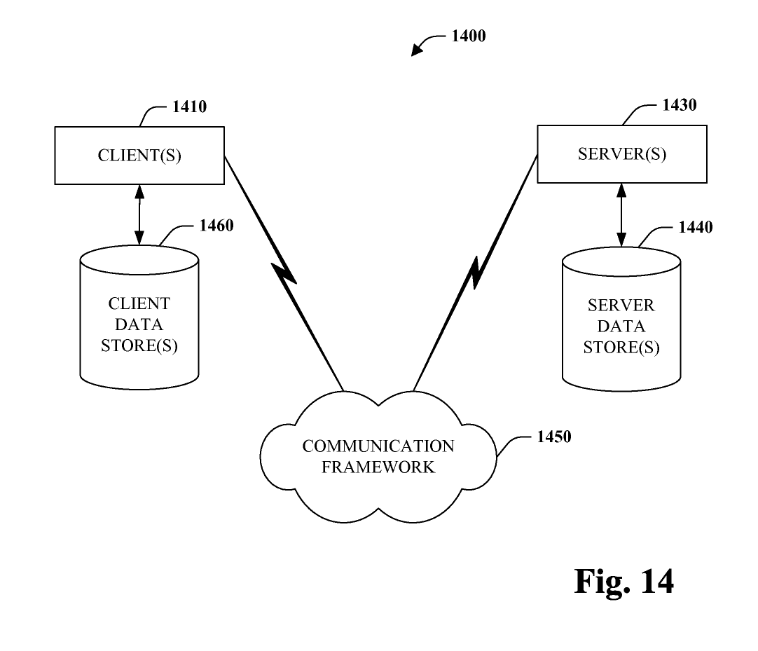

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 13, an exemplary environment 1310 for implementing various aspects disclosed herein includes a computer 1312 (e.g., desktop, laptop, server, hand held, programmable consumer or industrial electronics . . . ). The computer 1312 includes a processing unit 1314, a system memory 1316 and a system bus 1318. The system bus 1318 couples system components including, but not limited to, the system memory 1316 to the processing unit 1314. The processing unit 1314 can be any of various available microprocessors. It is to be appreciated that dual microprocessors, multi-core and other multiprocessor architectures can be employed as the processing unit 1314.

The system memory 1316 includes volatile and nonvolatile memory. The basic input/output system (BIOS), containing the basic routines to transfer information between elements within the computer 1312, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1312 also includes removable/non-removable, volatile/non-volatile computer storage media. FIG. 13 illustrates, for example, mass storage 1324. Mass storage 1324 includes, but is not limited to, devices like a magnetic or optical disk drive, floppy disk drive, flash memory or memory stick. In addition, mass storage 1324 can include storage media separately or in combination with other storage media.

FIG. 13 provides software application(s) 1328 that act as an intermediary between users and/or other computers and the basic computer resources described in suitable operating environment 1310. Such software application(s) 1328 include one or both of system and application software. System software can include an operating system, which can be stored on mass storage 1324, that acts to control and allocate resources of the computer system 1312. Application software takes advantage of the management of resources by system software through program modules and data stored on either or both of system memory 1316 and mass storage 1324.

The computer 1312 also includes one or more interface components 1326 that are communicatively coupled to the bus 1318 and facilitate interaction with the computer 1312. By way of example, the interface component 1326 can be a port (e.g., serial, parallel, PCMCIA, USB, FireWire . . . ) or an interface card (e.g., sound, video, network . . . ) or the like. The interface component 1326 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1312 to output device(s) via interface component 1326. Output devices can include displays (e.g., CRT, LCD, plasma . . . ), speakers, printers and other computers, among other things.

FIG. 14 is a schematic block diagram of a sample-computing environment 1400 with which the subject innovation can interact. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the aspects of the subject innovation, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. Here, the client(s) 1410 can correspond to program application components and the server(s) 1430 can provide the functionality of the interface and optionally the storage system, as previously described. The client(s) 1410 are operatively connected to one or more client data store(s) 1460 that can be employed to store information local to the client(s) 1410. Similarly, the server(s) 1430 are operatively connected to one or more server data store(s) 1440 that can be employed to store information local to the servers 1430.

By way of example, a program application component can request storage of personal health information to one or more servers 1430 (and an API stored thereupon or accessible therefrom, for example) via a client 1410. The server(s) 1430 can interpret the request and extract relevant data, conforming the data to a schema. The data is then stored in a data store 1440 or a plurality of data stores 1440 according to the specified schema, for example. Subsequently, other program application components can request access to the same or different data from the server(s) 1430.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system for storing personal health related data, comprising:
a health integration network that enables seamless access to health related data originating from a plurality of sources, the health integration network comprises a plurality of databases that respectively store health related data; and
a schema component that receives health related data, schematizes the health related data according to at least one schema, and stores the schematized data within the health integration network.

2. The system of claim 1, the health related data comprising an extensible markup language (XML) representation of at least one data value, the XML is at least a portion of data relating to a record.

3. The system of claim 2, the schema provides the XML stored in a record database, which is at least one of the plurality of databases, and the record stored in a directory database, which is at least one of the plurality of databases.

4. The system of claim 3, the schema further provides additional information related to the content of the XML stored with the XML, the additional information comprises an identifier of the record stored in the directory database.

5. The system of claim 3, the health related data has an associated data type, information regarding the associated data type is stored in a dictionary database, which is at least one of the plurality of databases, the schema provides an identifier of the data type stored with the XML stored in the record database.

6. The system of claim 5, the information regarding the associated data type comprises a schema definition of a structure of the XML.

7. The system of claim 3, the record database is highly distributed based at least in part on an employer of a user to which the health related data relates.

8. The system of claim 1, the schema component receives and stores binary data corresponding to the health related data.

9. The system of claim 9, the schema provides the binary data associated with the health related data via an identifier stored with both the binary data and the health related data.

10. A method for storing personal health related data, comprising:
receiving health related data;
applying at least one schema to the health related data to produce schematized data; and
storing the schematized data within at least one of a plurality of databases of a health integration network.

11. The method of claim 10, the schema provides an extensible markup language (XML) representation of at least one data value stored in a record database which is highly distributed among at least a subset of the plurality of databases.

12. The method of claim 11, the record database is segmented based at least in part on a regional location of a user to which data within the record database relates.

13. The method of claim 11, the schema provides at least one authorization rule for accessing the XML representation stored within a directory database, which is at least one of the plurality of databases.

14. The method of claim 13, the schema further provides information related to an application registered to utilize the health integration network stored within the directory database.

15. The method of claim 10, the schema provides a data type associated with the health related data stored in a dictionary database, which is at least one of the plurality of databases.

16. The method of claim 15, the schema further provides information related to the data type additionally stored in the dictionary database, the information comprises at least one stylesheet that is utilized to create a disparately formatted representation of the health related data.

17. The method of claim 16, the stylesheet defined by an application accessing the health integration network.

18. The method of claim 10, further comprising storing audit data relating to changes made to the health related data.

19. The method of claim 18, the schema provides at least one audit action type associated with the audit data stored with at least one of the plurality of databases.

20. A system for storing personal health data, comprising:
means for receiving health related data, the health related data comprises at least one XML representation of a data value;
means for associating the health related data with at least one data type, the data type previously stored according to a schema and having at least one stylesheet for transforming data of the data type to a disparate format;
means for schematizing the health related data and associated data type to conform with at least one schema of a database within a health integration network; and
means for storing the schematized data within the health integration network.
